(19) United States
(12) Patent Application Publication
(10) Pub. No.: US 2009/0019015 A1
(43) Pub. Date: Jan. 15, 2009

(54) MATHEMATICAL EXPRESSION STRUCTURED LANGUAGE OBJECT SEARCH SYSTEM AND SEARCH METHOD

(76) Inventor: Yoshinori Hijikata, Osaka (JP)

Correspondence Address: OSHA LIANG L.L.P., TWO HOUSTON CENTER, 909 FANNIN, SUITE 3500, HOUSTON, TX, 77010, US

(21) Appl. No.: 12/281,730

(22) PCT Filed: Mar. 14, 2007
(86) PCT No.: PCT/JP2007/055103

§ 371 Date: Sep. 4, 2008

(30) Foreign Application Priority Data
Mar. 15, 2006 (JP) 2006-070307

(51) Int. Cl. G06F 7/06; G06F 17/30

(52) U.S. Cl. 707/3; 707/E17.014

(57) ABSTRACT

A mathematical expression structured language object search system according to the present invention includes a mathematical expression structured language search engine (4) for collecting web documents having a mathematical expression structured language object embedded therein by a crawler beforehand based on a document tree structure of the mathematical expression structured language object, indexing the web documents using the document tree structure of the mathematical expression structured language object as an index term, and storing the indexed web documents in a database in the form of inverted files; a web browser serving as a client (1); and a server (3) for receiving search query information from the client (1), inputting a search query into the mathematical expression structured language search engine (3) based on the search query information, thereby performing a search and thus acquiring a web document or a web document part including a related mathematical expression structured language object, and then transmitting the acquired web document or web document part to the client (1).

### TECHNICAL FIELD

The present invention relates to a mathematical expression structured language object search system and method. In more detail, the present invention relates to a novel mathematical expression structured language object search system and method capable of detecting a mathematical expression included in a web document at high speed.

### BACKGROUND ART

Conventional web search engines search, based on a keyword, for a web document including the keyword. However, as search queries, character strings including only alphabets; numerical figures; or hiragana characters, katakana characters, kanji characters or symbols, the sizes of which are equal in vertical and horizontal directions, can be specified. Mathematical expressions cannot be specified as search queries. Therefore, the conventional search engines cannot search for mathematical expressions included in a web document.

Technologies of searching for similar mathematical expressions, which are targeted for MathML (Mathematics Markup Language) as a mathematical expression structured language, are being studied (Takafumi NAKANISHI, Sadaya KISHIMOTO, Mamoru MURAKATA, Toru OTSUKA, Tetsuya SAKURAI and Takashi KITAGAWA, “An Impression Method of Composite Association Retrieval System for Data of Mathematical Formulas”, The Database Society of Japan Letters, Vol. 4, No. 1, 2005). However, search for apart of a document relating to a mathematical expression, variable conversion, mathematical expression expansion and the like have not been realized. In addition, the above-mentioned technology of searching for similar mathematical expressions uses vector space models and has a problem that the search speed is low.

MathML is an XML-based mathematical expression language, which was published in April 1998 as being recommended by W3C (a consortium which proceeds with standardization of technologies used in WWW). (XML is one of the languages for describing the meanings of documents or data. A structure is embedded in the original document with a specific character string called “tag”. XML allows the user to specify his/her own tag.) With MathML, two types of tags are prepared for writing, and conveying the meaning of, a mathematical expression. A MathML file is usable independently and also is usable as being embedded in another XML document. In order to associate MathML with XHTML, web browsers compatible with MathML are expected to be developed.

### DISCLOSURE OF INVENTION

The present invention, made in light of the above-described circumstances, has an object of providing a novel mathematical expression structured language object search system and method capable of detecting a mathematical expression included in a web document at high speed and also capable of realizing search for a part of a document relating to a mathematical expression, variable conversion, mathematical expression expansion and the like.

For achieving the above-described object, the present invention first provides a mathematical expression structured language object search system comprising a mathematical expression structured language search engine for collecting web documents having a mathematical expression structured language object embedded therein by a crawler beforehand based on a document tree structure of the mathematical expression structured language object, indexing the web documents using the document tree structure of the mathematical expression structured language object as an index term, and storing the indexed web documents in a database in the form of inverted files; a web browser serving as a client; and a server for receiving search query information from the client, inputting a search query into the mathematical expression structured language search engine based on the search query information, thereby performing a search and thus acquiring a web document or a web document part including a related mathematical expression structured language object, and then transmitting the acquired web document or web document part to the client.

Second, the present invention provides a mathematical expression structured language object search system according to the first invention, wherein the search query information from the client is a web document part including a mathematical expression structured language object specified by a user; and the server extracts a keyword and the mathematical expression structured language object from the web document part and performs a search using the extracted keyword as the search query.

In the second invention above, the web document part including the mathematical expression structured language object specified by the client may be acquired by a pointing device operation event provided by the user.

Third, the present invention provides a mathematical expression structured language object search system according to the second invention, wherein the web document part including the mathematical expression structured language object specified by the client is acquired by a client program for detecting a pointing device operation by the user and causing the server to transmit the search query information of the specified document part, the client program being embedded in the web document provided to the client.

Fourth, the present invention provides a mathematical expression structured language object search system according to the first invention, wherein the acquisition, by the input of the search query, of the web document or the web document part in which the related mathematical expression structured language object is described is realized by using a document tree structure of the mathematical expression structured language object.

Fifth, the present invention provides a mathematical expression structured language object search system according to the first invention, wherein the mathematical expression structured language search engine manages a web document file including the mathematical expression structured language object as an inverted file having a data management structure indexed using a character string held between tags of a mathematical expression structured language.

Sixth, the present invention provides a mathematical expression structured language object search system according to the fifth invention, wherein the server acquires a search result from the inverted file having the indexed data management structure using a path defining language for document structure access.

Seventh, the present invention provides a mathematical expression structured language object search system according to the sixth invention, wherein the server inspects whether all the paths in the document tree structure of the mathematic expression structured language acquired as the search result is compatible with the search query using the path defining language for document structure access.

Eighth, the present invention provides a mathematical expression structured language object search system according to the seventh invention, wherein the server detects a leaf node site at which variable names are different by checking character strings of all the leaf nodes in the document tree structure of the mathematical expression structured language object.

Ninth, the present invention provides a mathematical expression structured language object search system according to the eighth invention, wherein the server performs variable conversion by replacing a character string of the detected leaf node with a character string included in the search query.

Preferable embodiments of the mathematical expression structured language object search system according to the present invention include the following.

In the above invention, the extracted related web document or web document part is inserted as a sibling or child node of the object for which an event occurred in the web document on which the user performed a pointing device operation.

In the above invention, the server receives search query information on two mathematical expression structured language objects specified by the user, and extracts, as search queries, the two mathematical expression structured language objects from the received search query. Then, the server acquires a web document part including at least one mathematical expression structured language object which is present between the two mathematical expression structured language objects and thus performs an expression expansion search.

In the above invention, the server checks the character strings of all the leaf nodes of the document tree structure of at least one mathematical expression structured language object which is present between the two mathematical expression structured language objects specified by the user to find a leaf node site at which variable names are different, and replaces the character string at the detected leaf node with a character string included in the search query to perform variable conversion.

In the above invention, the client program replaces a partial structure of the document tree structure including the two mathematical expression structured language objects specified by the user with the acquired partial structure, or inserts the acquired partial structure as a sibling or child object of the two mathematical expression structured language objects specified by the user.

In the above invention, the mathematical expression structured language is MathML (Mathematics Markup Language).

In the above invention, the document tree is DOM (Document Object Model).

In the above invention, the path defining language for document tree access is XPath (XML Path Language).

In the above invention, the pointing device is a mouse.

In the above invention, the search query information from the client is a MathML object which is directly input using a graphical mathematical expression editor or a text editor.

Tenth, the present invention provides a method for searching for a mathematical expression structured language object, comprising using a mathematical expression structured language search engine for collecting web documents having a mathematical expression structured language object embedded therein by a crawler beforehand based on a document tree structure of the mathematical expression structured language object, indexing the web documents using the document tree structure of the mathematical expression structured language object as an index term, and storing the indexed web documents in a database in the form of inverted files; and the server receiving search query information from a web browser serving as the client, inputting a search query into the mathematical expression structured language search engine based on the search query information, thereby performing a search and thus acquiring a web document or a web document part including a related mathematical expression structured language object, and then transmitting the acquired web document or web document part to the client.

Eleventh, the present invention provides a method for searching for a mathematical expression structured language object according to the tenth invention, wherein the search query information from the client is a web document part including a mathematical expression structured language object specified by a user; and the server extracts a keyword and the mathematical expression structured language object from the web document part and performs a search using the extracted keyword as the search query.

In the eleventh invention, the web document part including the mathematical expression structured language object specified by the client may be acquired by a pointing device operation event provided by the user.

Twelfth, the present invention provides a method for searching for a mathematical expression structured language object according to the eleventh invention, wherein the web document part including the mathematical expression structured language object specified by the client is acquired by a client program for detecting a pointing device operation by the user and causing the server to transmit the search query information of the specified document part, the client program being embedded in the web document provided to the client.

Thirteenth, the present invention provides a method for searching for a mathematical expression structured language object according to the tenth invention, wherein the acquisition, by the input of the search query, of the web document or the web document part in which the related mathematical expression structured language object is described is realized by using a document tree structure of the mathematical expression structured language object.

Fourteenth, the present invention provides a method for searching for a mathematical expression structured language object according to the tenth invention, wherein the mathematical expression structured language search engine manages a web document file including the mathematical expression structured language object as an inverted file having a data management structure indexed using a character string held between tags of a mathematical expression structured language.

Fifteenth, the present invention provides a method for searching for a mathematical expression structured language object according to the fourteenth invention, wherein the server acquires a search result from the inverted file having the indexed data management structure using a path defining language for document structure access.

Sixteenth, the present invention provides a method for searching for a mathematical expression structured language object according to the fifteenth invention, wherein the server inspects whether all the paths in the document tree structure of the mathematic expression structured language acquired as the search result is compatible with the search query using the path defining language for document structure access.

Seventeenth, the present invention provides a method for searching for a mathematical expression structured language object according to the sixteenth invention, wherein the server detects a leaf node site at which variable names are different by checking character strings of all the leaf nodes in the document tree structure of the mathematical expression structured language object.

Eighteenth, the present invention provides a method for searching for a mathematical expression structured language object according to the seventeenth invention, wherein the server performs variable conversion by replacing a character string at the detected leaf node with a character string included in the search query.

Preferable embodiments of the method for searching for a mathematical expression structured language object according to the present invention include the following.

In the above invention, the extracted related web document or web document part is inserted as a sibling or child node of the object for which an event occurred in the web document on which the user performed a pointing device operation.

In the above invention, the server receives search query information on two mathematical expression structured language objects specified by the user, and extracts, as search queries, the two mathematical expression structured language objects from the received search query. Then, the server acquires a web document part including at least one mathematical expression structured language object which is present between the two mathematical expression structured language objects and thus performs expression expansion.

In the above invention, the server checks the character strings of all the leaf nodes of the document tree structure of at least one mathematical expression structured language object which is present between the two mathematical expression structured language objects specified by the user to find a leaf node site at which variable names are different, and replaces the character string at the detected leaf node with a character string included in the search query to perform variable conversion.

In the above invention, the server causes the client program to replace a partial structure of the document tree structure including the two mathematical expression structured language objects specified by the user with the acquired partial structure.

In the above invention, the mathematical expression structured language is MathML (Mathematics Markup Language).

In the above invention, the document tree is DOM (Document Object Model).

In the above invention, the path defining language for document tree access is XPath (XML Path Language).

In the above invention, the pointing device is a mouse.

In the above invention, the search query information from the client is a MathML object which is directly input using a graphical mathematical expression editor or a text editor.

The present invention also provides a mathematical expression structured language object search program for causing a computer to execute any of the methods for searching for a mathematical expression structured language object described above.

The present invention also provides a computer-readable recording medium having the above-mentioned mathematical expression structured language object search program recorded thereon, for example, a flexible disc, a CD, a DVD, or an magneto-optical disc.

Herein, the term “MathML” is as described above, and the terms “mathematical expression structured language”, “document tree structure”, “YDOMT”, “XPath” and “indexing” respectively refer to the following.

The term “mathematical expression structured language” refers to a language, for example, MathML, by which a mathematical expression is described with a structured language like XML.

The term “document tree structure” refers to a document structure obtained as a tree structure by analyzing a tag of a DOM (Document Object Model) structure or a structured document.

The term “DOM” refers to an application programming interface (API) for a web document like an HTML document or an XML document standardized by W3C. DOM defines a method by which a computer accesses or operates a logical structure of a document or a part of the document based on such a structure. Specifically, a web document structured by a tag is represented as a tree structure on a computer program, and the computer can freely access the document structure or the part of the document based on the structure, using the tree structure.

The term “path defining language for document structure access” refers to a language which defines a path, for example, XPath, for accessing a document structure.

The term “XPath” refers to a language which defines a description method for indicating a specific element in an XML document. XPath is a standard specification recommended by W3C. XPath is also an independent description system, used in XSLT or XPointer, for specifying a position. A basic description method is as follows. A root node, which is an apex of a document tree, is represented with “/”. The elements are traced while being punctuated with “/”, and the names thereof are described sequentially. For example, in order to refer to the value of “b” in the element “a”, “/a/b” is described. Complicated position specification including a conditional expression or a mathematical operation can be performed using a node data type, a node type or a name space (XML namespace).

The term “indexing” refers to processing of extracting a search term from a text. In order to complete an indexing system, it is necessary to extract, from the text, an index term which characterizes the text.

According to the present invention, a document search using a mathematic expression as a query can be performed at high speed.

According to the present invention, the following conspicuous effects are provided: a mathematical expression to be a query can be easily input by a mouse operation; a web document part related to a mathematical expression compatible with the search can be dynamically embedded in the web document which is being browsed; even if a different variable name is used in the mathematical expression, a search and retrieval can be performed if the structure of the mathematical expression is the same; the variable name of the mathematical expression as the search result can be embedded in the state of being converted in conformation to the variable name of the mathematical expression in the web document which is being browsed; and when an expression of the expansion source and an expression of the expansion destination are specified for the search query, a web document describing such an expression expansion can be searched for and retrieved.

The present invention is expected to contribute to the industries including generation of education contents, re-construction service of education contents, similarity search for patents or documents of scientific technologies, mathematical expression search service, portal service for mathematical expression libraries, web advertisement service for the above-mentioned products or services, and the like.

### BRIEF DESCRIPTION OF DRAWINGS

FIG. 1 schematically shows a structure of one embodiment of a mathematic expression structured language object search system according to the present invention.

FIG. 2 is a flowchart showing a procedure for performing a related document search by a MathML object search system shown in FIG. 1.

FIG. 3 is a flowchart showing a procedure for performing a related document search by the MathML object search system shown in FIG. 1.

FIG. 4 is a flowchart showing a procedure for performing a related document search by the MathML object search system shown in FIG. 1.

FIG. 5 is a flowchart showing a procedure for performing a related document search by the MathML object search system shown in FIG. 1.

FIG. 6 is a flowchart showing a procedure for performing a related document search by the MathML object search system shown in FIG. 1.

FIG. 7 is a flowchart showing a procedure for performing a related document search by the MathML object search system shown in FIG. 1.

FIG. 8 is a flowchart showing a procedure for performing a related document search by the MathML object search system shown in FIG. 1.

FIG. 9 illustrates extraction of a partial tree on a DOM tree.

FIG. 10 shows an example of extraction of a keyword and a MathML object.

FIG. 11 shows an XPath representation of the left-end path during a depth-first search.

FIG. 12 shows XPath representations of all the paths.

FIG. 13 is a flowchart showing a procedure for performing an expression expansion search by the MathML object search system shown in FIG. 1.

FIG. 14 is a flowchart showing a procedure for performing an expression expansion search by the MathML object search system shown in FIG. 1.

FIG. 15 is a flowchart showing a procedure for performing an expression expansion search by the MathML object search system shown in FIG. 1.

FIG. 16 is a flowchart showing a procedure for performing an expression expansion search by the MathML object search system shown in FIG. 1.

FIG. 17 is a flowchart showing a procedure for performing an expression expansion search by the MathML object search system shown in FIG. 1.

FIG. 18 is a flowchart showing a procedure for performing an expression expansion search by the MathML object search system shown in FIG. 1.

FIG. 19 is a flowchart showing a procedure for performing an expression expansion search by the MathML object search system shown in FIG. 1.

FIG. 20 is a flowchart showing a procedure for performing an expression expansion search by the MathML object search system shown in FIG. 1.

FIG. 21 is a flowchart showing a procedure for performing an expression expansion search by the MathML object search system shown in FIG. 1.

### BEST MODE FOR CARRYING OUT THE INVENTION

The present invention has the features described above, and an embodiment thereof will be described below.

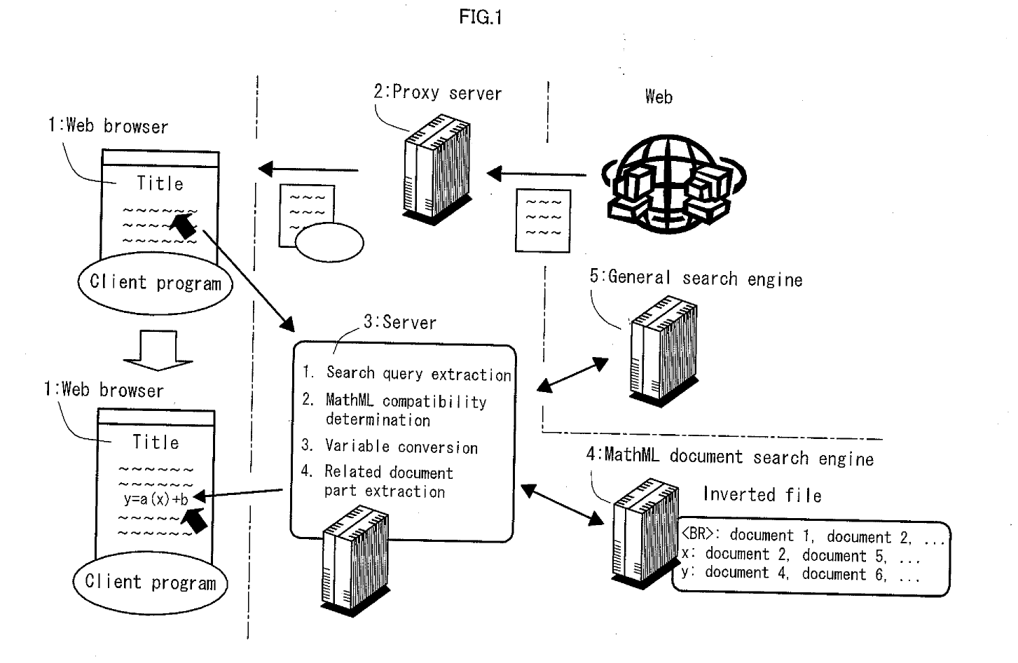

FIG. 1 schematically shows one embodiment of a mathematical expression structured language object search system according to the present invention.

In this embodiment, MathML is used as a mathematical expression structured language, DOM is used as a document tree structure, and XPath is used as an application programming interface, for example.

A MathML object search system in this embodiment includes a web browser located on the user side and serving as a client (1); a proxy server (2) as a unit for embedding a client program provided for detecting a mouse operation by a user, in a web document to be provided to a web browser, of the client (1), located on the center side; a server (3) for performing a service of searching for a related web document part including a MathML object; a MathML document search engine (4) capable of searching for and retrieving a web document including a MathML object using MathML as a search query, and a general search engine (5). As shown in FIG. 1, the server (3) has functions of search query extraction, MathML compatibility determination, variable conversion, related document part extraction and the like. The client program has functions of detecting an occurrence of a mouse event provided by the user, transmitting a web document part including a MathML object specified by the user to the server (3), inserting the extracted related web document or web document part which has been returned from the server (3) to the object in which the event occurred, and the like. Either one, or both, of the proxy server (2) and the MathML document search engine (4) may be integral with, or separate from, the server (3).

The MathML document search engine (4) collects many web documents, on the web of the Internet, having a MathML object embedded therein by a crawler beforehand based on the DOM structure of the MathML object, indexes the web documents using the DOM structure of the MathML object as an index term, and stores the indexed web documents in a database in the form of inverted files. In actuality, the URLs of the web document files are stored. The inverted files managed in the database are updated when necessary.

In this embodiment, search query information is transmitted from the client (1) to the server (3). The server (3) inputs the search query to the MathML document search engine (4) based on the search query information to perform a search. After acquiring a web document or a web document part including the related MathML object, the server (3) returns the search query information to the client (1). The search query information to be transmitted from the client (1) to the server (3) may be of any of various forms. Specifically, such search query information may be a MathML mathematical expression itself, a MathML mathematical expression which is input by a graphical mathematical expression editor generally used, a MathML mathematical expression which is input by entering an XML tag using a text editor, or a web document part including the MathML object.

Hereinafter, the MathML object search system in this embodiment will be described. Specifically, a processing procedure for searching for a document part related to a web document part including the MathML object specified by the user (related document search), and a processing procedure for, based on two MathML objects specified by the user, searching for a document part which describes an expression expansion between the two expressions (expression expansion search), will be described separately in detail.

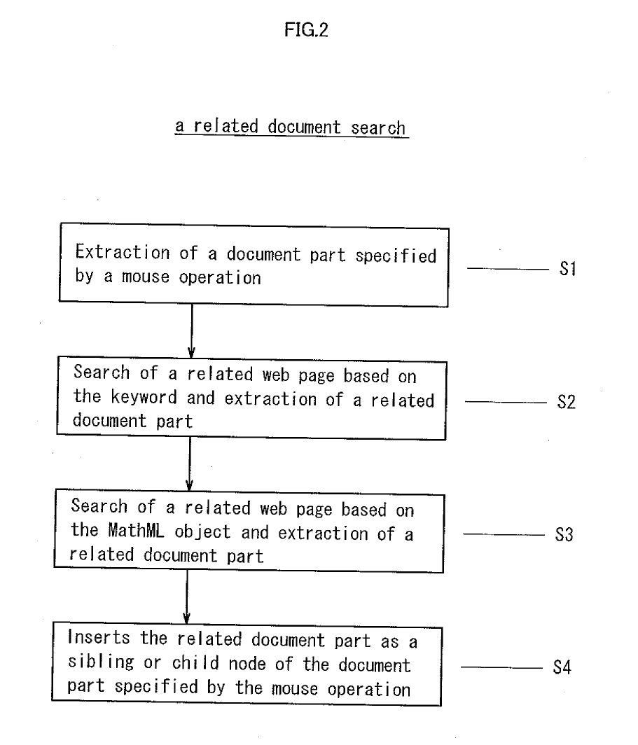

First, with reference to the flowcharts in FIG. 2 through FIG. 8, a related document search will be described.

<Related Document Search>

[1] Extraction of a document part specified by a mouse operation conducted by the user (step S1 in FIG. 2)

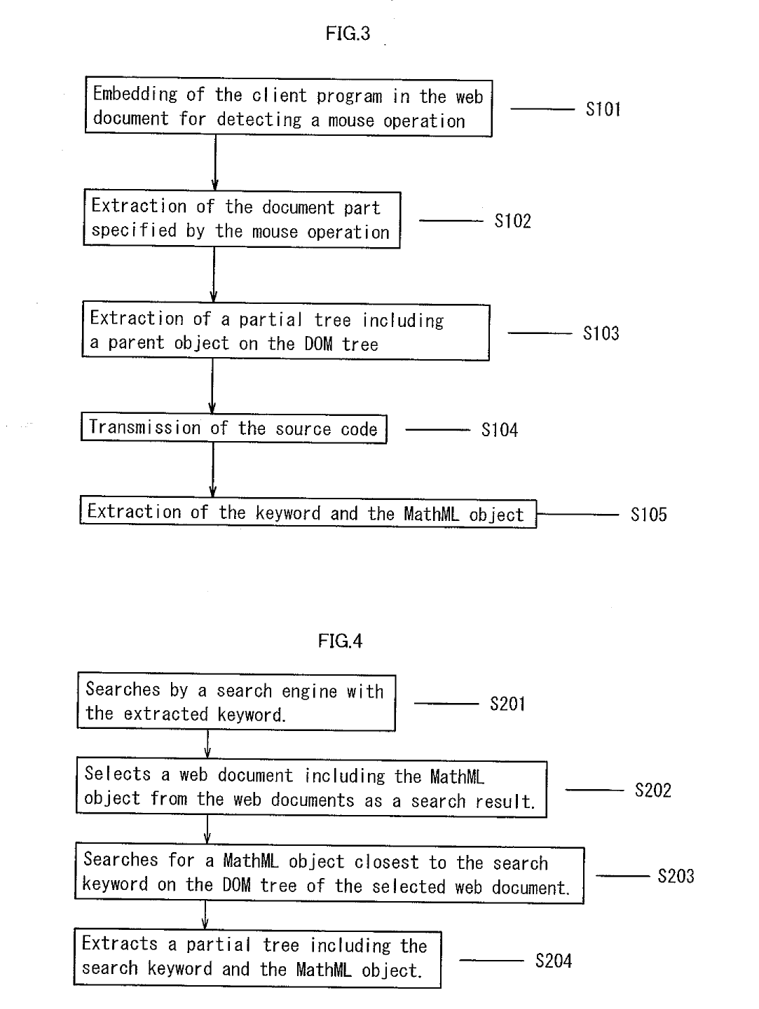

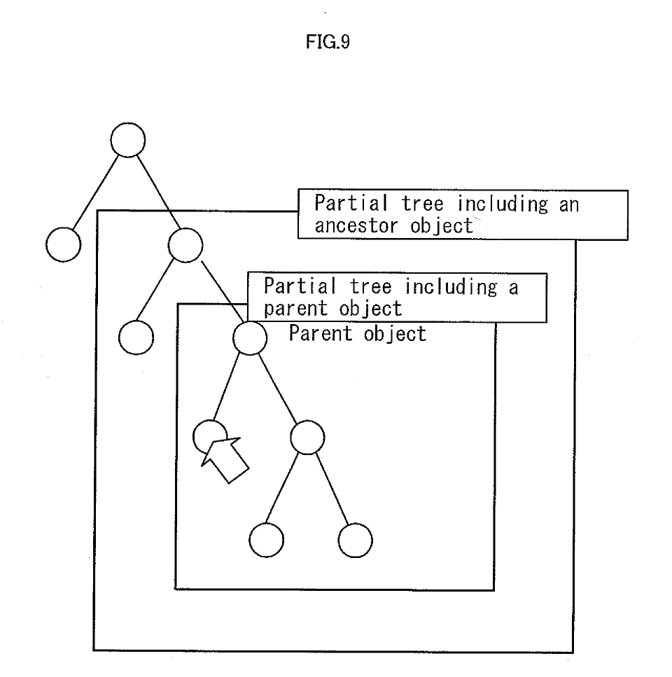

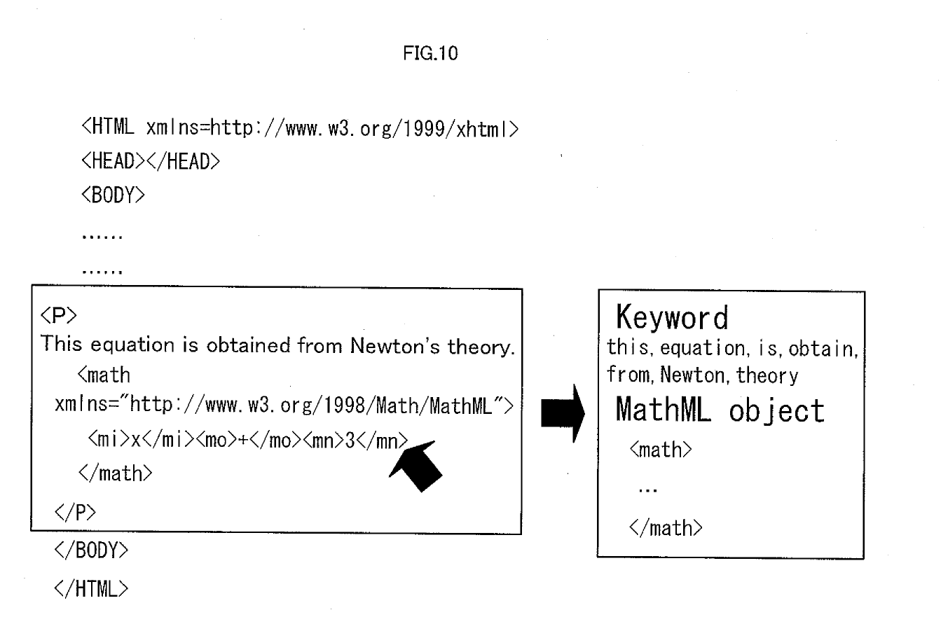

First, the user acquires a web page including a desired MathML object using the client (1). In this operation, the proxy server (2) embeds a client program for detecting a mouse operation by the user in the web document in the client (1) (step S101 in FIG. 3). The user specifies a web document part including the MathML object by a mouse operation. The client program in the client (1) detects the mouse operation by the user to extract the document part specified by the mouse operation (step S102) and thus extracts a partial tree including a parent object (or an ancestor object within a specified range) on a DOM tree of the object for which the mouse event occurred (see step S103 and FIG. 9). The client program in the client (1) transmits a source code of the extracted partial tree to the server (3) (step S104). The server (3) extracts a keyword and the MathML object from the received source code (see step S105 and FIG. 10).

[2] Search for the related web page based on the keyword and extraction of the related document part (step 2 in FIG. 2)

The server (3) causes the MathML document search engine (4) to perform a search with the extracted keyword (step S201 in FIG. 4), and selects web documents including the MathML object from the web documents acquired as a search result (step S202). A MathML object which is positioned closest to the search keyword on the DOM tree structure of the selected web documents is found (step S203), and a partial tree including the search keyword and the MathML object (or a partial tree including an ancestor object in a specified range from the root node of the partial tree entered in [1]) is extracted (step S204).

The MathML object which is positioned closest to the search keyword on the DOM tree structure of the selected web documents may be found, for example, as follows. From the node on the DOM tree structure having the search keyword, the ancestor nodes or descendant nodes thereof are traced. The MathML object which is positioned closest to the search keyword on the route of the ancestor nodes or the route of the descendant nodes is specified. A minimum possible partial tree including the node on the DOM tree structure having the search keyword and also including such a MathML object is extracted. Specifically, in the case where the node having the search keyword is at a higher level than the MathML object in the DON structure, the entire structure below the node having the keyword is extracted. In the case where the MathML object is at a higher level than the node having the search keyword in the DOM structure, the entire structure below the MathML object is extracted.

[3] Search for the related web page based on the MathML object and extraction of the related document part (step S3 in FIG. 2)

The server (3) obtains the DOM structure of the extracted MathML object (hereinafter, referred to as the “search source DOM structure”) and performs the processing as follows.

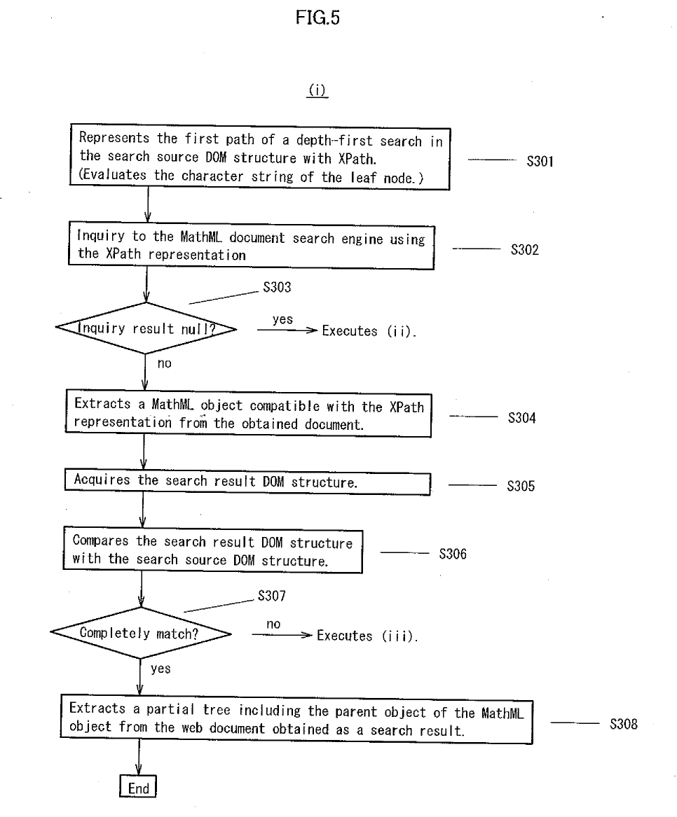

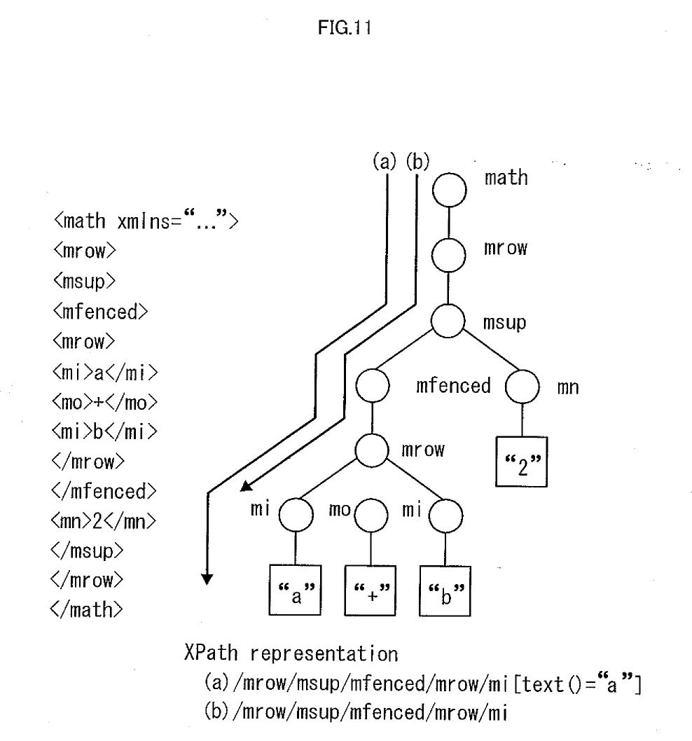

(i) The first path of a depth-first search in the search source DOM structure is represented with XPath (step S301 in FIG. 5). It should be noted that for the XPath representation, the character string value of the leaf node is evaluated (see FIG. 11(a)). Using the XPath representation, an inquiry is made to the MathML document search engine (4) (step S302). An input for the search is given with XPath. In step S303, when the result of the inquiry is null, (ii) below is executed. When the result of the inquiry is not null, a MathML object compatible with the XPath representation is extracted from the web document obtained as a result of the inquiry (step S304), and the DON structure of the MathML object (search result DON structure) is acquired (step S305). Then, the search result DOM structure is compared with the search source DOM structure (step S306). In this operation, it is checked whether or not even the character string values of the leaf nodes match each other. In order to perform this comparison, XPath representations of the paths from the root up to all the leaf nodes are acquired (for the XPath representation, the character string value of the leaf node is evaluated) (see FIG. 12(a)), and it is checked whether or not the XPath representations match each other in all the paths in terms of both the number and content (step S307). When the XPath representations completely match each other, a partial tree including a parent object of the MathML object (or a partial tree including an ancestor object in a specified range from the parent object) is extracted from the web document obtained as a search result. Then, the procedure is terminated (step S308). When the XPath representations do not match each other, (iii) is executed.

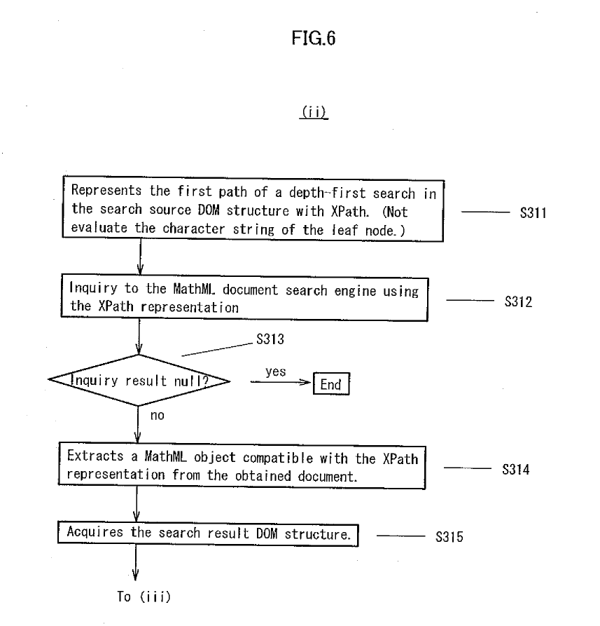

(ii) The first path of a depth-first search in the search source DOM structure is represented with XPath (step S311 in FIG. 6). It should be noted that for the XPath representation, the character string value of the leaf node is not evaluated (see FIG. 11(b)). Using the XPath representation, an inquiry is made to the MathML document search engine (4) (step S312). In step S313, it is determined whether the result of the inquiry is null or not. When the result of the inquiry is null, it is determined that there is no related document part and the procedure is terminated. When the result of the inquiry is not null, a MathML object compatible with the XPath representation is extracted from the web document obtained as a result of the inquiry (step S314), and the DOM structure of the MathML object (search result DOM structure) is acquired (step S315). Then, (iii) below is executed.

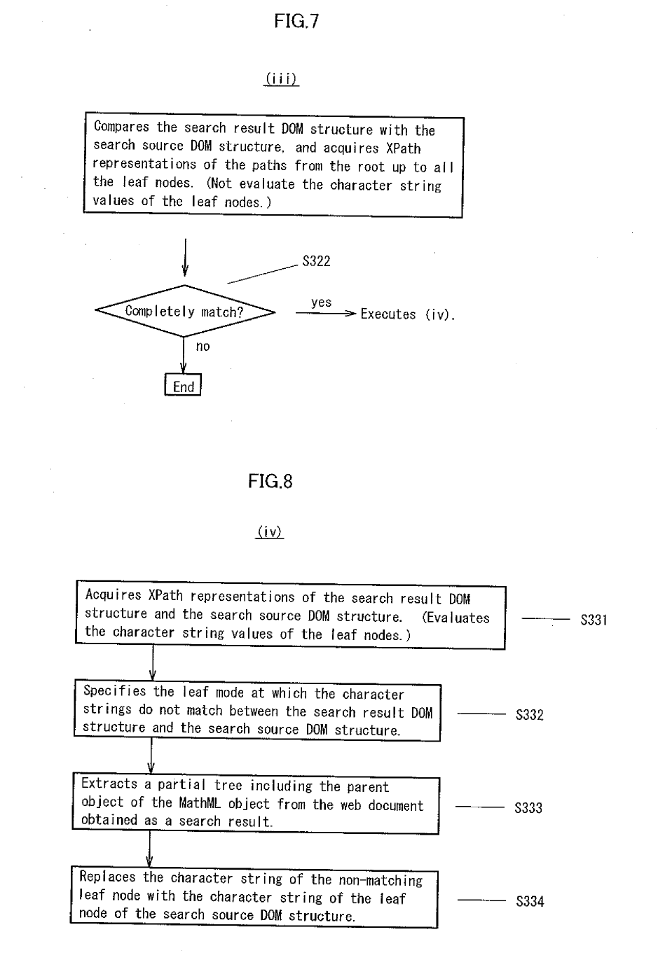

(iii) The search result DOM structure is compared with the search source DOM structure (step S321 in FIG. 7). In order to perform this comparison, XPath representations of the paths from the root up to all the leaf nodes are acquired (for the XPath representations, the character string values of the leaf nodes are not evaluated) (see FIG. 12(b)), and it is checked whether or not the XPath representations match each other in all the paths in terms of both the number and content. In the comparison in step S322, when the XPath representations completely match each other, (iv) below is executed. When not, it is determined that there is no related document part and the procedure is terminated.

(iv) The leaf node site at which the character strings do not match between the search result DOM structure and the search source DON structure is specified. In order to perform this specification, XPath representations of both the DOM structures are acquired (for the XPath representations, the character string values of the leaf nodes are evaluated) (steps S331 and S332 in FIG. 8), and the leaf node site at which the XPath representations do not match each other is found. A partial tree including a parent object of the MathML object (or a partial tree including an ancestor object in a specified range from the parent object) is extracted from the web document obtained as a search result (step S333), and the character string of the above-mentioned non-matching leaf node is replaced with the character string of the leaf node of the search source DOM structure (step S334).

In the above example, the MathML document search engine (4) manages the web documents including a MathML object. Alternatively, the MathML document search engine (4) may manage a MathML object itself or web document parts including a MathML object.

The MathML document search engine (4) is installed as an inverted file. The inverted file may be of any of a version in which only the first path of the DOM structure of the MathML is stored as the index, a version in which all the paths of the DOM structure of the MathML are stored as the index, or a version in which a plurality of specified paths of the DOM structure of the MathML are stored as the index.

[4] Embedding of the related document part (step S4 in FIG. 2)

The related web document part extracted in [2] or [3] above is transmitted to the client program in the client (1) The client program inserts the extracted related web document part as a node of a sibling or a child of the object at which the mouse operation event occurred.

In the case where a document part related to the web document originally browsed is dynamically inserted, one web document selected from the web documents returned as the search result and inserted into the related document part is displayed on the screen of the client (1) in the final stage. After the insertion, a next candidate may be re-inserted.

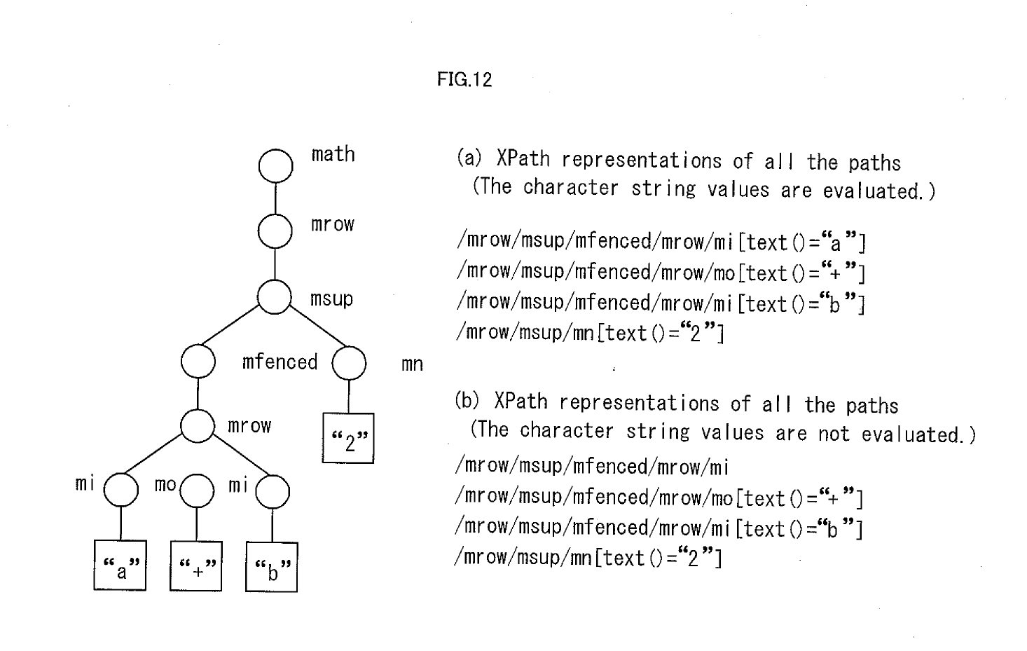

Now, with reference to the flowcharts in FIG. 13 through FIG. 21, an expression expansion search will be described.

<Expression Expansion Search>

[5] Extraction of MathML objects specified by a mouse operation conducted by the user (step S5 in FIG. 13)

The client (1) detects a mouse operation by the user with a client program embedded in a web document by [1] described above (step S501 in FIG. 14). Next, the client (1) acquires two MathML objects in which a specific mouse event occurred (step S502). The client (1) then transmits the source codes of the two MathML objects to the server (3) (step S503). The server (3) extracts the MathML objects based on the received source codes (step S504).

[6] Search for a related web page from the MathML objects (step S6 in FIG. 13).

The server (3) searches for a related web page as follows.

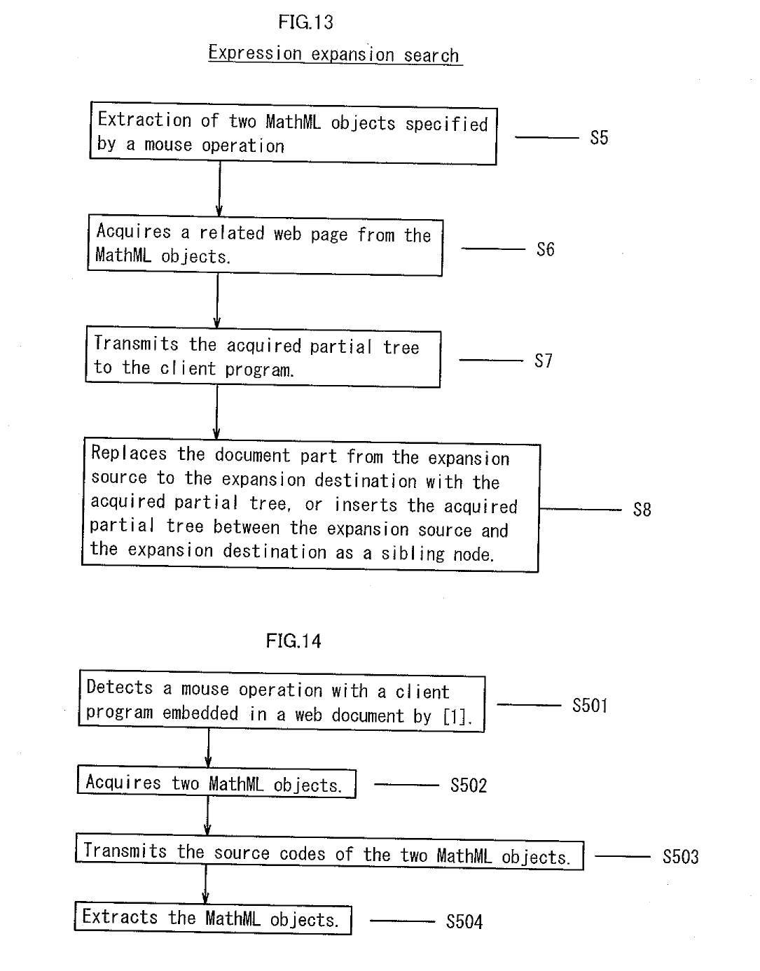

(i) Document tree structures of the extracted two MathML objects (hereinafter, referred to as the “search source document tree structures”) are acquired (step S601 in FIG. 15). The document tree structure of the first MathML object will be referred to as the “search source document tree structure (expansion source)”, and the document tree structure of the second MathML object will be referred to as the “search source document tree structure (expansion destination)”. The first path of a depth-first search in the search source document tree structure (expansion source) is represented with XPath (the character string value of the leaf node is evaluated) (step S602), and an inquiry is made to the MathML document search engine (4) (step S603). In step S604, it is determined whether the result of the inquiry is null or not. When the result of the inquiry is null, (iv) below is executed. When the result of the inquiry is not null, (ii) below is executed.

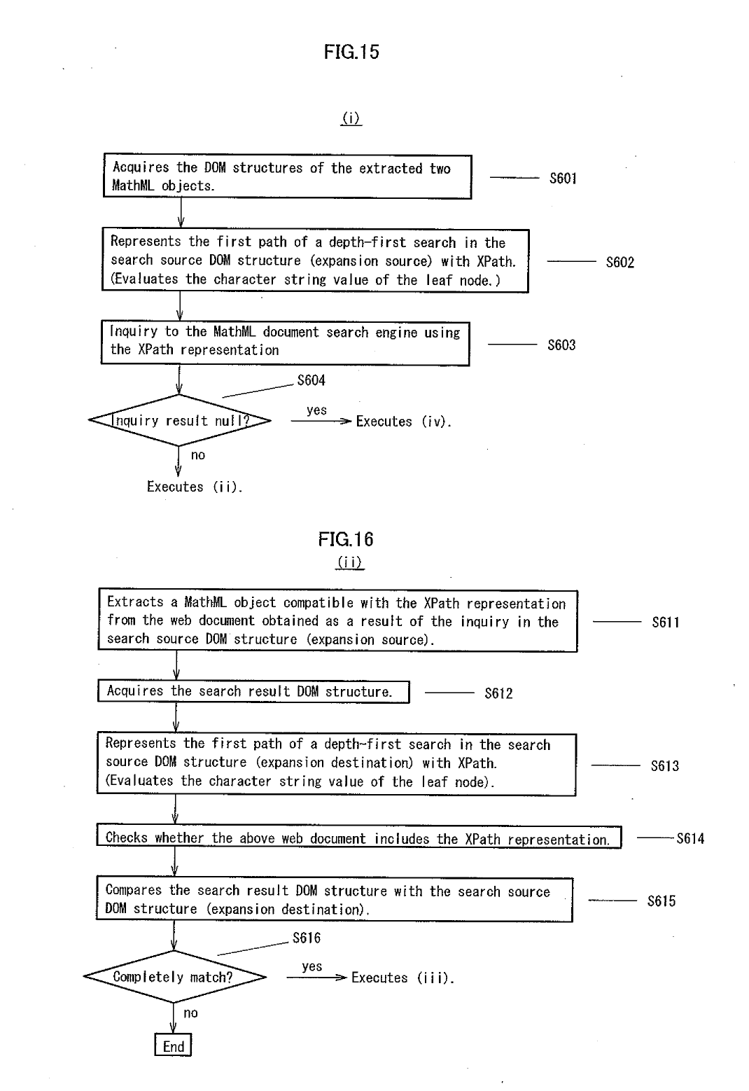

(ii) From the web document obtained as a result of the inquiry in the search source document tree structure (expansion source), a MathML object compatible with the XPath representation is extracted (step S611 in FIG. 16), and a document tree structure of the MathML object is acquired (step S612). The acquired document tree structure is compared with the search source document tree structure (expansion source). In this operation, it is checked whether or not even the character string values of the leaf nodes match each other. The first path of a depth-first search in the search source document tree structure (expansion destination) is represented with XPath (the character string value of the leaf node is evaluated) (step S613), and it is checked whether or not the above-mentioned web document includes a MathML object including this XPath representation (step S614). When such a MathML object is included, a document tree structure of the MathML object is acquired. The acquired document tree structure is compared with the search source document tree structure (expansion destination) (step S615). In this operation, it is checked whether or not even the character string values of the leaf nodes match each other. When there are document tree structures completely matching each other as a result of these two comparisons, (iii) below is executed. When not, the procedure is terminated.

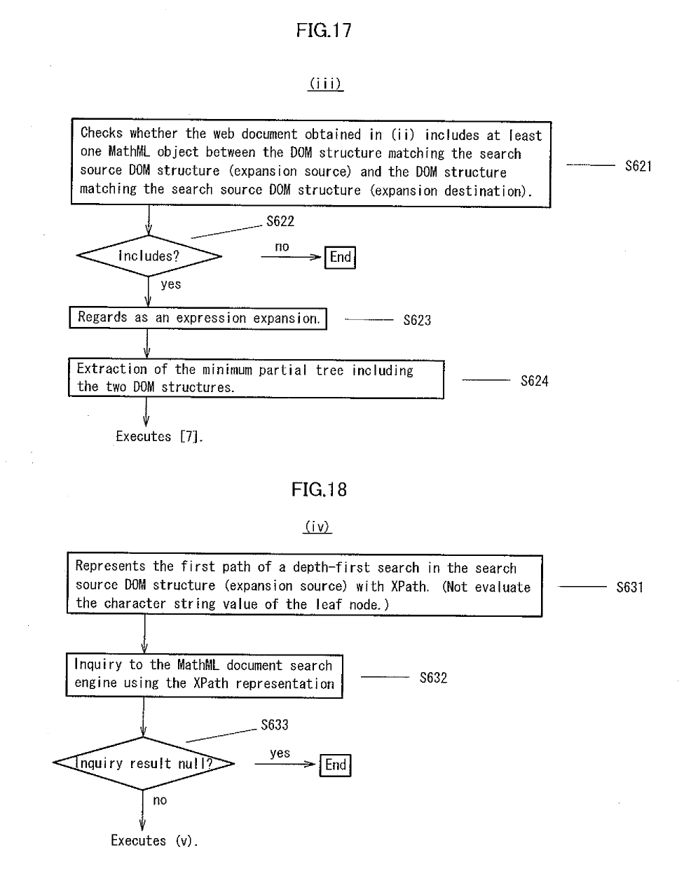

(iii) It is checked whether or not the web document obtained in (ii) above includes at least one MathML object between the document tree structure matching the search source document tree structure (expansion source) and the document tree structure matching the search source document tree structure (expansion destination) (steps S621 and S622 in FIG. 17). When at least one MathML object is included, this is regarded as an expression expansion (step S623). Then, a minimum partial tree including the two document tree structures (or a partial tree including an ancestor object within a specified range from the root object of the minimum partial tree) is extracted (step S624), and procedure [7] below is executed. When no MathML object is included, the procedure is terminated.

(iv) The first path of a depth-first search in the search source document tree structure (expansion source) is represented with XPath (step S631 in FIG. 18). It should be noted that the character string value of the leaf node is not evaluated. Using the XPath representation, an inquiry is made to the MathML document search engine (4) (step S632). In step S633, it is determined whether the result of the inquiry is null or not. When the result of the inquiry is null, it is determined that there is no related document part and the procedure is terminated. When the result of the inquiry is not null, (v) below is executed.

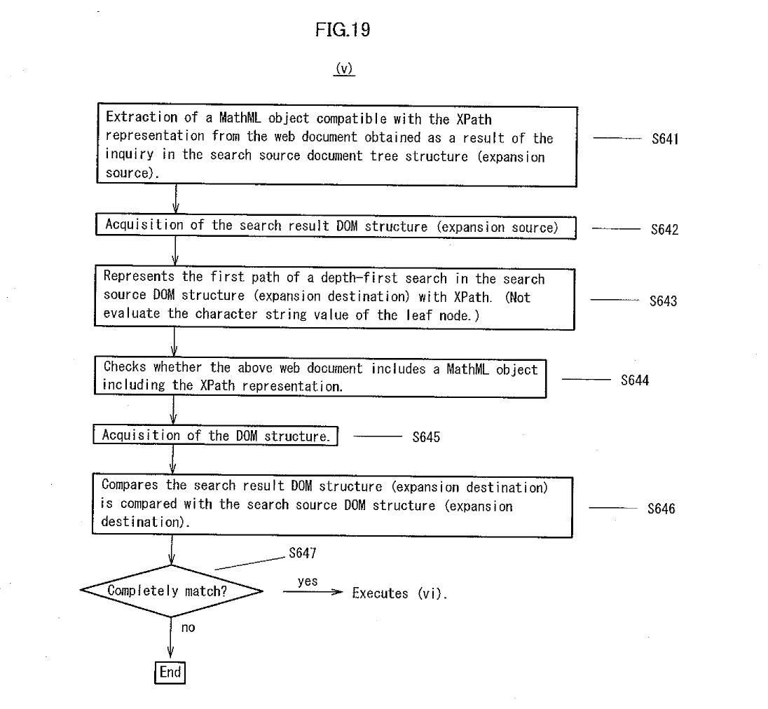

(v) From the web document obtained as a result of the inquiry in the search source document tree structure (expansion source), a MathML object compatible with the XPath representation is extracted (step S641 in FIG. 19), and a document tree structure of the MathML object (hereinafter, referred to as the “search result document tree structure (expansion source)”) is acquired (step S642). Then, the search result document tree structure (expansion source) is compared with the search source document tree structure (expansion source). The character string values of the leaf nodes are not evaluated. The first path of a depth-first search in the search source document tree structure (expansion destination) is represented with XPath (the character string value of the leaf node is not evaluated) (step S643). It is checked whether or not the above-mentioned web document includes a MathML object including this XPath representation (step S644). When such a MathML object is included, a document tree structure of the MathML object (hereinafter, referred to as the “search result document tree structure (expansion destination)”) is acquired (step S645). The search result document tree structure is compared with the search source document tree structure (expansion destination) (steps S646 and S647). The character string values of the leaf nodes are not evaluated. When there are document tree structures completely matching each other as a result of these two comparisons, (vi) below is executed. When not, the procedure is terminated.

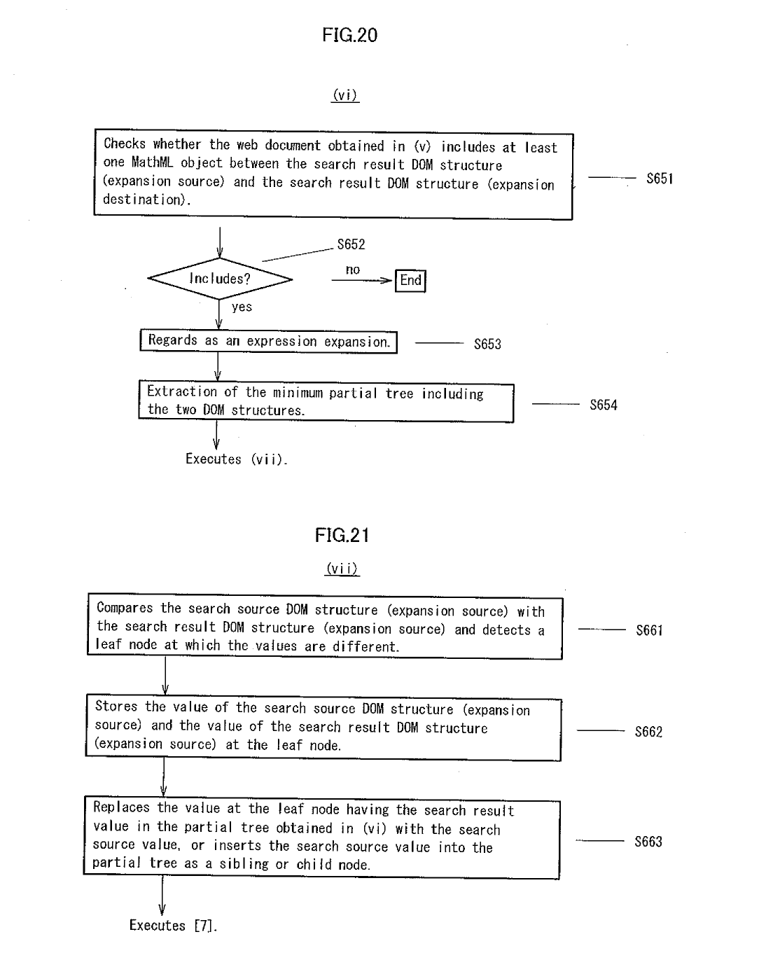

It is checked whether or not the web document obtained in (v) above includes at least one MathML object between the search result document tree structure (expansion source) and the search result document tree structure (expansion destination) (steps S651 and S652 FIG. 20). When at least one MathML object is included, this is regarded as an expression expansion (step S653). Then, a minimum partial tree including the two document tree structures (or a partial tree including an ancestor object within a specified range from the root object of the minimum partial tree) is extracted (step S654), and (vii) below is executed. When no MathML object is included, the procedure is terminated.

(vii) The search source document tree structure (expansion source) is compared with the search result document tree structure (expansion source), and a leaf node at which the values are different is detected (step S661 in FIG. 21). The value of the search source document tree structure (expansion source) at the leaf node (hereinafter, referred to as the “search source value”) and the value of the search result document tree structure (expansion source) at the leaf node (hereinafter, referred to as the “search result value”) are stored (step S662). In all the MathML objects which are present between the search result document tree structure (expansion source) and the search result document tree structure (expansion destination) in the partial tree obtained in (vi), the value at the leaf node having the search result value are replaced with the search source value (step S663). Then, [7] below is executed.

[7] The acquired partial tree is transmitted to the client program (step S7 in FIG. 13).

[8] The client program replaces the document part from the search source document tree structure (expansion source) up to the search source document tree structure (expansion destination) with the acquired partial tree, or inserts the acquired partial tree as a sibling object of the search source document tree structure (expansion source) and the search source document tree structure (expansion destination) or a child object of the search source document tree structure (expansion source) (step S8 in FIG. 13).

The above-described related document search mode and expression expansion search mode may be switched to each other as follows, for example. When a client program is downloaded to a web browser and executed, a window for the client program is opened. A radio button or the like is switched on the window by a mouse operation. Alternatively, in the case where a plurality of objects specified by a mouse drag operation include at least two MathML objects, a popup window is displayed when the drag operation is terminated (when the button of the mouse is released). A radio button or the like is switched on the window by a mouse operation. However, the manner of mode switching is not limited to the above.

In the above, the expression expansion search is described with an example in which the MathML document search engine (4) manages web documents including a MathML object, like for the related document search. Alternatively, the MathML document search engine (4) may manage a MathML object itself, or web document parts including a MathML object.

The inverted file installed in the MathML document search engine (4) may be of any of a version in which only the first path of the DOM structure of the MathML is stored as the index, a version in which all the paths of the DOM structure of the MathML are stored as the index, or a version in which a plurality of specified paths of the DOM structure of the MathML are stored as the index.

The present invention has been described based on one embodiment thereof. The present invention is not limited to the above-described embodiment and may be modified or altered in various manners.

For example, in the above embodiment, search query information from the client is a web document part including a mathematical expression structured language object specified by the user. Alternatively, search query information from the client may be a MathML object which is directly input using a graphical mathematical expression editor or a text editor. In this case, like a usual search engine, titles of a plurality of web documents and portions around the input MathML object in each web document can be displayed as snippets (summary texts including, and in the vicinity of, the input keyword).

In the above embodiment, MathML is used as the mathematical expression structured language, DOM is used as a document tree structure, and XPath is used as the application programming interface. The present invention is not limited to this, and anything having an equivalent function is usable.

1. A mathematical expression structured language object search system, comprising:
a mathematical expression structured language search engine for collecting web documents having a mathematical expression structured language object embedded therein by a crawler beforehand based on a document tree structure of the mathematical expression structured language object, indexing the web documents using the document tree structure of the mathematical expression structured language object as an index term, and storing the indexed web documents in a database in the form of inverted files;
a web browser serving as a client; and
a server for receiving search query information from the client, inputting a search query into the mathematical expression structured language search engine based on the search query information, thereby performing a search and thus acquiring a web document or a web document part including a related mathematical expression structured language object, and then transmitting the acquired web document or web document part to the client.

2. A mathematical expression structured language object search system according to claim 1, wherein the search query information from the client is a web document part including a mathematical expression structured language object specified by a user; and the server extracts a keyword and the mathematical expression structured language object from the web document part and performs a search using the extracted keyword as the search query.

3. A mathematical expression structured language object search system according to claim 2, wherein the web document part including the mathematical expression structured language object specified by the client is acquired by a client program for detecting a pointing device operation by the user and causing the server to transmit the search query information of the specified document part, the client program being embedded in the web document provided to the client.

4. A mathematical expression structured language object search system according to claim 1, wherein the acquisition, by the input of the search query, of the web document or the web document part in which the related mathematical expression structured language object is described is realized by using a document tree structure of the mathematical expression structured language object.

5. A mathematical expression structured language object search system according to claim 1, wherein the mathematical expression structured language search engine manages a web document file including the mathematical expression structured language object as an inverted file having a data management structure indexed using a character string held between tags of a mathematical expression structured language.

6. A mathematical expression structured language object search system according to claim 5, wherein the server acquires a search result from the inverted file having the indexed data management structure using a path defining language for document structure access.

7. A mathematical expression structured language object search system according to claim 6, wherein the server inspects whether all the paths in the document tree structure of the mathematic expression structured language acquired as the search result is compatible with the search query using the path defining language for document structure access.

8. A mathematical expression structured language object search system according to claim 7, wherein the server detects a leaf node site at which variable names are different by checking character strings of all the leaf nodes in the document tree structure of the mathematical expression structured language object.

9. A mathematical expression structured language object search system according to claim 8, wherein the server performs variable conversion by replacing a character string of the detected leaf node with a character string included in the search query.

10. A method of searching for a mathematical expression structured language object, comprising:
using a mathematical expression structured language search engine for collecting web documents having a mathematical expression structured language object embedded therein by a crawler beforehand based on a document tree structure of the mathematical expression structured language object, indexing the web documents using the document tree structure of the mathematical expression structured language object as an index term, and storing the indexed web documents in a database in the form of inverted files; and
the server receiving search query information from a web browser serving as the client, inputting a search query into the mathematical expression structured language search engine based on the search query information, thereby performing a search and thus acquiring a web document or a web document part including a related mathematical expression structured language object, and then transmitting the acquired web document or web document part back to the client.

11. A method of searching for a mathematical expression structured language object according to claim 10, wherein the search query information from the client is a web document part including a mathematical expression structured language object specified by a user; and the server extracts a keyword and the mathematical expression structured language object from the web document part and performs a search using the extracted keyword as the search query.

12. A method of searching for a mathematical expression structured language object according to claim 11, wherein the web document part including the mathematical expression structured language object specified by the client is acquired by a client program for detecting a pointing device operation by the user and causing the server to transmit the search query information of the specified document part, the client program being embedded in the web document provided to the client.

13. A method of searching for a mathematical expression structured language object according to claim 10, wherein the acquisition, by the input of the search query, of the web document or the web document part in which the related mathematical expression structured language object is described is realized by using a document tree structure of the mathematical expression structured language object.

14. A method of searching for a mathematical expression structured language object according to claim 10, wherein the mathematical expression structured language search engine manages a web document file including the mathematical expression structured language object as an inverted file having a data management structure indexed using a character string held between tags of a mathematical expression structured language.

15. A method of searching for a mathematical expression structured language object according to claim 14, wherein the server acquires a search result from the inverted file having the indexed data management structure using a path defining language for document structure access.

16. A method of searching for a mathematical expression structured language object according to claim 15, wherein the server inspects whether all the paths in the document tree structure of the mathematic expression structured language acquired as the search result is compatible with the search query using the path defining language for document structure access.

17. A method of searching for a mathematical expression structured language object according to claim 16, wherein the server detects a leaf node site at which variable names are different by checking character strings of all the leaf nodes in the document tree structure of the mathematical expression structured language object.

18. A method of searching for a mathematical expression structured language object according to claim 17, wherein the server performs variable conversion by replacing a character string of the detected leaf node with a character string included in the search query.
